(19) United States
(12) Patent Application Publication
(10) Pub. No.: US 2010/0134351 A1
(43) Pub. Date: Jun. 3, 2010

(54) GPS SIGNAL TRANSMISSION APPARATUS

(76) Inventors: Tsai-Yi Yang, Kuntien Hsiang (TW); Ching-Wen Wu, Kuntien Hsiang (TW); Kun-Lin Yang, Kuntien Hsiang (TW); Der-Fen Chu, Kuntien Hsiang (TW)

Correspondence Address: HDLS Patent & Trademark Services, P.O. BOX 220746, CHANTILLY, VA, 20153-0746, US

(21) Appl. No.: 12/325,461

(22) Filed: Dec. 1, 2008

(51) Int. Cl. G01S 1/00

(52) U.S. Cl. 342/357.06

(57) ABSTRACT

A GPS signal transmission apparatus includes a DC converter with a GPS power unit and an auxiliary power unit, an external GPS antenna, an RF amplifier and an internal GPS antenna. The DC converter receiving a DC power from a cigarette lighter and supplies electrical power to the RF amplifier, a GPS device through the GPS power unit, and portable electronic devices through the auxiliary power unit. The external GPS antenna receives a GPS signal and the GPS signal is amplified by the RF amplifier and then sent to the internal GPS antenna. Therefore, the GPS signal can be sent to the GPS device in wireless manner by the internal GPS antenna.

### BACKGROUND OF THE INVENTION

1. Field of the Invention

The present invention relates to a GPS signal transmission apparatus, especially to a GPS signal transmission apparatus guiding a remote GPS signal into a vehicle in wired manner and then broadcasting in the vehicle in wireless manner, and the GPS signal transmission apparatus supplying electrical power to the GPS device and other portable electronic devices.

2. Description of Prior Art

Global Positioning System (GPS) has been extensively used in vehicle navigation, and vehicle user gradually replace paper map with GPS device for navigation. FIG. 1 is a schematic view showing the application of a prior art vehicle navigation device. The vehicle navigation device is placed inside a vehicle such as a car to receive GPS signal from a GPS satellite 2. However, the GPS signal is tended to be blocked by window film 4 or metal casing 6 of the car. Therefore, vehicle navigation device cannot have best performance due to the blockage of signal.

To cope with this problem, external antenna is developed to arrange on external face of car casing and then the received signal is wired to the vehicle navigation device inside the car. However, some of the vehicle navigation devices are not equipped with antenna socket. Therefore, wireless vehicle navigation device is developed where the external antenna is also arranged on external face of car casing and then the received signal is wired to a cigarette lighter in the car. Afterward, a wireless transmitter electrically connected to the cigarette lighter send wireless navigation signal to the vehicle navigation device inside the car. However, the cigarette lighter is adapted to power the wireless transmitter only and cannot provide electrical power to the vehicle navigation device. Moreover, many users are used to charge their MP3 player, mobile phone or mobile phone battery through cigarette lighter (or cigarette lighter with USB adapter). The above mentioned vehicle navigation device using cigarette lighter as wireless transmitter is inconvenient for user having other portable electronic devices.

### SUMMARY OF THE INVENTION

It is an object of the present invention to provide a GPS signal transmission apparatus guiding a remote GPS signal into a vehicle in wired manner and then sending the GPS signal in the vehicle in wireless manner, and the GPS signal transmission apparatus supplying electrical power to the GPS device and other portable electronic devices.

Accordingly, the present invention provides a GPS signal transmission apparatus, which includes a DC converter with a GPS power unit and an auxiliary power unit, an external GPS antenna, an RF amplifier and an internal GPS antenna. The DC converter receiving a DC power from a cigarette lighter and supplies electrical power to the RF amplifier, a GPS device through the GPS power unit, and portable electronic devices through the auxiliary power unit. The external GPS antenna receives a GPS signal and the GPS signal is amplified by the RF amplifier and then sent to the internal GPS antenna. Therefore, the GPS signal can be sent to the GPS device in wireless manner.

The GPS signal transmission apparatus of the present invention not only guides the external GPS signal inside the car in wired manner and then sent the GPS signal to the GPS device in wired manner, but also provides electrical power to the GPS device and the portable electronic device.

### BRIEF DESCRIPTION OF THE DRAWINGS

FIG. 1 is a schematic view showing the application of a prior art vehicle navigation device.

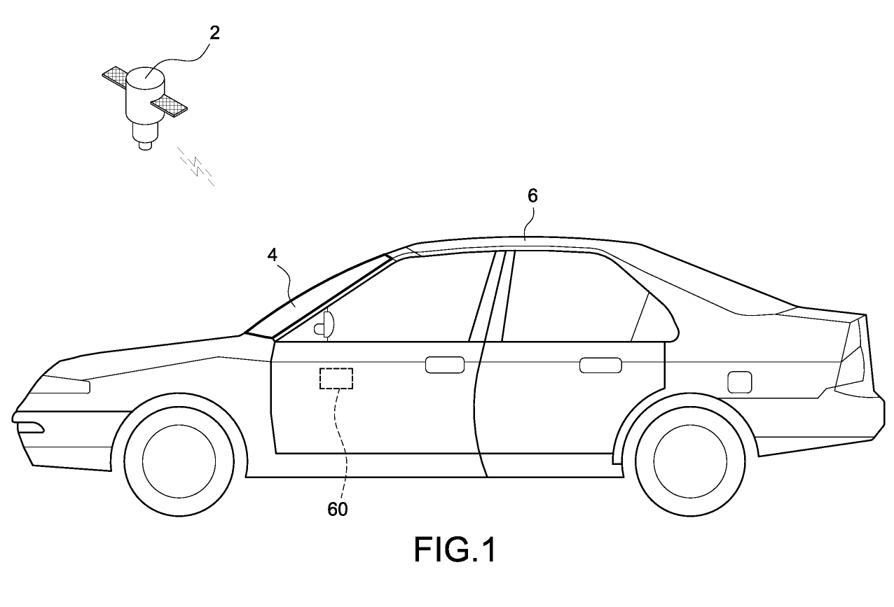

FIG. 2 shows the schematic view of the GPS signal transmission apparatus of the present invention.

### DETAILED DESCRIPTION OF THE INVENTION

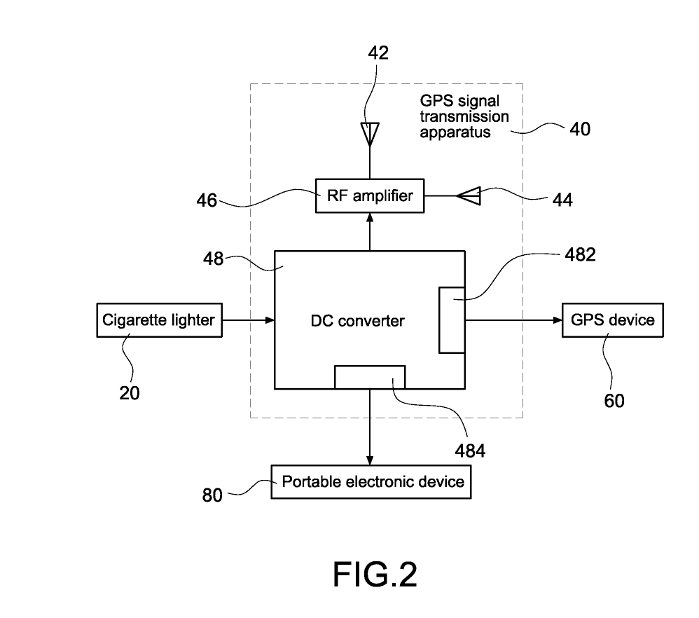

FIG. 2 shows the schematic view of the GPS signal transmission apparatus of the present invention. The GPS signal transmission apparatus 40 comprises a DC converter 48, an external GPS antenna 42 arranged outside a car, an RF amplifier 46 arranged outside the car, and an internal GPS antenna 44 arranged inside the car. The DC converter 48 further comprises at least two power output units, namely, a GPS power unit 482 and at least one auxiliary power unit 484, where only one auxiliary power unit 484 is demonstrated for simplicity. The RF amplifier 46 is electrically connected to the external GPS antenna 42, the internal GPS antenna 44 and the DC converter 48.

The DC converter 48 receives a DC power from a cigarette lighter 20 inside the car and converts the DC power to driving power for other units. The driving power includes power supplied to the RF amplifier 46, the power from the GPS power unit 482 and supplied to a GPS device 60 inside the car, and power from the auxiliary power unit 484 and supplied to a portable electronic device 80 such as MP3 player (not shown), mobile phone (not shown) or mobile phone battery charger (not shown). The external GPS antenna 42 receives an external GPS signal from satellite and sends the external GPS signal to the RF amplifier 46 for signal amplification. The amplified GPS signal is then sent from the internal GPS antenna 44 to the GPS device 60 in wireless manner.

The GPS signal transmission apparatus of the present invention not only guides the external GPS signal inside the car in wired manner and then sent the GPS signal to the GPS device 60 in wired manner, but also provides electrical power to the GPS device 60 and the portable electronic device 80.

What is claimed is:

1. A GPS (global positioning system) signal transmission apparatus used for a vehicle with a cigarette lighter and providing a GPS signal to a GPS device, the GPS signal transmission apparatus comprising:
a DC converter receiving a DC power from the cigarette lighter and providing at least two output powers, wherein one output power is supplied to the GPS device;
an external GPS antenna arranged outside the vehicle and receiving an external GPS signal;
an RF amplifier arranged outside the vehicle and electrically connected to the DC converter and the external GPS antenna; and
an internal GPS antenna arranged inside the vehicle and electrically connected to the RF amplifier,
wherein the RF amplifier receives an electrical power from the DC converter, and amplifying the external GPS signal and then sending the amplified GPS signal to the internal GPS antenna in wired manner, whereby the amplified GPS signal can be sent to the GPS device in wireless manner by the internal GPS antenna.

2. The GPS signal transmission apparatus in claim 1, wherein the other power output of the DC converter is supplied to a portable electronic device.

3. The GPS signal transmission apparatus in claim 2, wherein the portable electronic device is MP3 player, mobile phone, or mobile phone battery charger.
